(19) United States
(12) Patent Application Publication
(10) Pub. No.: US 2008/0301085 A1
(43) Pub. Date: Dec. 4, 2008

(54) Dynamic Database File Column Statistics for Arbitrary Union Combination

(76) Inventors: Michael S. Faunce, Rochester, MN (US); Wei Hu, Rochester, MN (US); Shantan Kethireddy, Rochester, MN (US); Andrew Peter Passe, Rochester, MN (US); Ulrich Thiemann, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/755,954

(22) Filed: May 31, 2007

(51) Int. Cl. G06F 7/00

(52) U.S. Cl. 707/2

(57) ABSTRACT

Embodiments of the invention provide techniques for generating database statistics for optimizing union queries. In general, working sets including samples of values in database columns are persistently maintained in a database. To optimize a union query, the working sets describing the columns included in the union query are combined to generate an ad hoc working set. The ad hoc working set is then used to generate a database statistic describing the combined columns. In another embodiment, working sets may also be maintained for generating statistics for optimizing non-union queries, thus enabling statistics to be refreshed more frequently.

### BACKGROUND OF THE INVENTION

1. Field of the Invention

The invention generally relates to computer database systems. More particularly, the invention relates to techniques for providing dynamic column statistics for database unions.

2. Description of the Related Art

Databases are well known systems for storing, searching, and retrieving information stored in a computer. The most prevalent type of database used today is the relational database, which stores data using a set of tables that may be reorganized and accessed in a number of different ways. Users access information in relational databases using a relational database management system (DBMS).

Each table in a relational database includes a set of one or more columns. Each column typically specifies a name and a data type (e.g., integer, float, string, etc.), and may be used to store a common element of data. For example, in a table storing data about patients treated at a hospital, each patient might be referenced using a patient identification number stored in a “patient ID” column. Reading across the rows of such a table would provide data about a particular patient. Tables that share at least one attribute in common are said to be “related.” Further, tables without a common attribute may be related through other tables that do share common attributes. A path between two tables is often referred to as a “join,” and columns from tables related through a join may be combined to from a new table returned as a set of query results.

A query of a relational database may specify which columns to retrieve data from, how to join the columns together, and conditions (predicates) that must be satisfied for a particular data item to be included in a query result table. One common type of database query is a union query. In a union query, the results of two or more queries are combined into a single result set that includes all the rows that belong to all queries in the union. In some union queries, only unique values are returned (i.e., duplicate values are eliminated).

Current relational databases require that queries be composed in query languages. Today, the most widely used query language is Structured Query Language (SQL). However, other query languages are also used. Once composed, a query is executed by the DBMS. Typically, the DBMS interprets the query to determine a set of steps (hereafter referred to as a “query plan”) that must be carried out to execute the query. However, in most cases, there are alternative query plans that can be carried out to execute a given query. Thus, the DBMS often includes a query optimizer, which selects the query plan that is likely to be the most efficient (i.e., requiring the fewest system resources, such as processor time and memory allocation).

Query optimizers typically operate by evaluating database statistics, including column statistics. That is, the query plan is selected based on statistical characteristics of the data in the fields (i.e., columns) required for the query. Conventionally, database statistics are static, and are refreshed periodically to reflect changes to the data. The frequency of refreshing the statistics is usually determined by balancing the processing time required to generate the statistics against the savings in processing time resulting from query optimization. That is, if the database statistics are refreshed too frequently, then more system resources will be consumed in generating the statistics than will be saved by the use of the statistics in query optimization.

Some typical column statistics include the column cardinality (i.e., the number of distinct values in the column), and the Frequent Value List (FVL), which identifies the most populous values in the column. However, most conventional column statistics are not suitable for optimizing union queries. This is because, conventionally, the statistics describing the columns being joined by the union query cannot be combined in a meaningful way. For example, the cardinality statistics for each column cannot be combined, since there may be duplicate values present in two columns being combined in a union query. That is, if a first column has a cardinality statistic of 100 distinct values, and a second column has a cardinality statistic of 200 distinct values, we cannot assume that the union of the columns will have 300 distinct values, since there may be complete or partial overlap between the values of the two columns.

Therefore, there is a need for techniques for generating database statistics for optimizing union queries.

### SUMMARY OF THE INVENTION

One embodiment of the invention provides a computer-implemented method for generating a database statistic for optimizing union queries, comprising: receiving a union query for joining data from at least two data columns; identifying at least two working sets, each comprising data values sampled from a different column of the at least two columns, wherein the at least two working sets are maintained persistently in a database; generating an ad hoc working set comprising data values of the at least two working sets; and generating a database statistic based on the ad hoc working set.

Another embodiment of the invention provides a computer readable storage medium containing a program which, when executed, performs an operation, comprising: receiving a union query for joining data from at least two data columns; identifying at least two working sets, each comprising data values sampled from a different column of the at least two columns, wherein the at least two working sets are maintained persistently in a database; generating an ad hoc working set comprising data values of the at least two working sets; and generating a database statistic based on the ad hoc working set.

Yet another embodiment of the invention includes a system, comprising: a database; a group of working sets maintained persistently in the database; and a processor configured to: receive a union query for joining data from at least two data columns, identify at least two working sets, each comprising data values sampled from a different column of the at least two columns, generate an ad hoc working set comprising data values of the at least two working sets, and generate a database statistic based on the ad hoc working set.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a network environment, according to one embodiment of the invention.

FIGS. 2A-2B illustrate conceptual views of working sets used for generating database statistics for optimizing union queries, according to one embodiment of the invention.

FIG. 3 illustrates a flow diagram illustrating a method for generating database statistics for optimizing union queries, according to one embodiment of the invention.

### DETAILED DESCRIPTION OF THE PREFERRED EMBODIMENTS

Embodiments of the invention provide techniques for generating database statistics for optimizing union queries. In general, working sets including samples of values in database columns are persistently maintained in a database. To optimize a union query, the working sets describing the columns included in the union query are combined to generate an ad hoc working set. The ad hoc working set is then used to generate a database statistic describing the combined columns. In another embodiment, working sets may also be maintained for generating statistics for optimizing non-union queries, thus enabling statistics to be refreshed more frequently.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

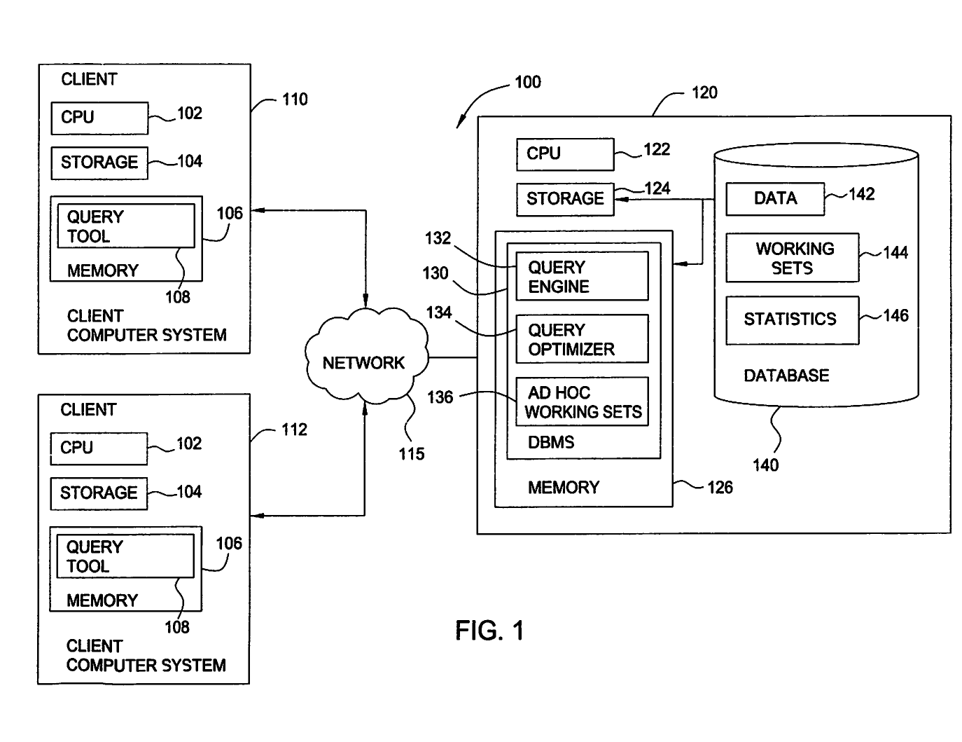

FIG. 1 is a block diagram that illustrates a client server view of computing environment 100, according to one embodiment of the invention. As shown, computing environment 100 includes two client computer systems 110 and 112, network 115 and server system 120. In one embodiment, the computer systems illustrated in environment 100 may include existing computer systems, e.g., desktop computers, server computers laptop computers, tablet computers, and the like. The computing environment 100 illustrated in FIG. 1, however, is merely an example of one computing environment. Embodiments of the present invention may be implemented using other environments, regardless of whether the computer systems are complex multi-user computing systems, such as a cluster of individual computers connected by a high-speed network, single-user workstations, or network appliances lacking non-volatile storage. Further, the software applications illustrated in FIG. 1 and described herein may be implemented using computer software applications executing on existing computer systems, e.g., desktop computers, server computers, laptop computers, tablet computers, and the like. However, the software applications described herein are not limited to any currently existing computing environment or programming language, and may be adapted to take advantage of new computing systems as they become available.

As shown, client computer systems 110 and 112 each include a CPU 102, storage 114 and memory 106, typically connected by a bus (not shown). CPU 102 is a programmable logic device that performs all the instruction, logic, and mathematical processing in a computer. Storage 104 stores application programs and data for use by client computer systems 110 and 112. Storage 104 includes hard-disk drives, flash memory devices, optical media and the like. The network 115 generally represents any kind of data communications network. Accordingly, the network 115 may represent both local and wide are networks, including the Internet. The client computer systems 110 and 112 are also shown to include a query tool 108. In one embodiment, the query tool 108 is software application that allows end users to access information stored in a database (e.g., database 140). Accordingly, the query tool 108 may allow users to compose and submit a query to a database system, which, in response, may be configured to process the query and return a set of query results. The query tool 108 may be configured to compose queries in a database query language, such as Structured Query Language (SQL). However, it should be noted that the query tool 108 is only shown by way of example; any suitable requesting entity may submit a query (e.g., another application, an operating system, etc.).

In one embodiment, the server 120 includes a CPU 122, storage 124, memory 126, a database 140, and a database management system (DBMS) 130. The database 140 includes data 142, working sets 144 and statistics 146. The data 142 represents the substantive data stored by the database 140. The statistics 146 may be generated by the DBMS 130, and may include various elements of metadata describing the characteristics of the database 140. In one embodiment, the statistics 146 may describe the properties of specific columns of the database 140 (i.e., column statistics). For example, the statistics 146 may include the cardinality of a given column (i.e., the number of distinct values in the column), the most-frequently occurring values of a given column, the distribution of values in a given column, a histogram (i.e., a partition of the column values into bands), and the like.

The database 140 contains the data managed by the DBMS 130. At various times, elements of the database 140 may be present in storage 124 and memory 126. The DBMS 130 provides a software application used to organize, analyze, and modify information stored in a database 140. The DBMS 130 includes a query engine 132, a query optimizer 134, and ad hoc working sets 136. The query engine 132 may be configured to process database queries submitted by a requesting application (e.g., a query generated using query tool 108) and to return a set of query results to the requesting application. The query optimizer 134 may be configured to select an efficient query plan, or series of executed instructions, for executing a query. More specifically, the query optimizer 134 selects the efficient query plan by determining which query plan is likely to require the fewest system resources (e.g., processor time, memory allocation, etc.) To make this determination, the query optimizer 134 utilizes the statistics 146, which describe characteristics of the fields (i.e., columns) included in the query.

In one embodiment, the statistics 146 are generated from the working sets 144, which each include data sampled from a given column of the database 140. The working sets 144 may be stored persistently (i.e., not temporarily) in the database 140. Each working set 144 may be configured to suit a specific statistic 146 that will be generated from the working set 144. In particular, the number of records in the working set 144 may be specified to achieve a desired level of statistical accuracy for the statistic 146. For example, a working set 144 used to generate a cardinality statistic of a column may be specified to include 10,000 records sampled from the column. In another example, a working set 144 used to generate a Frequent Value List (FVL) statistic (i.e., the most frequently-occurring values) of a column may be specified to include 2000 records sampled from the column. In these examples, the number of records in a working set 144 may be specified based on the minimum number of records required to achieve a desired level of statistical accuracy, as is known in the art. It should be noted that these examples are intended to be illustrative. It is contemplated that the working sets 144 may be configured as suited to a particular use or application.

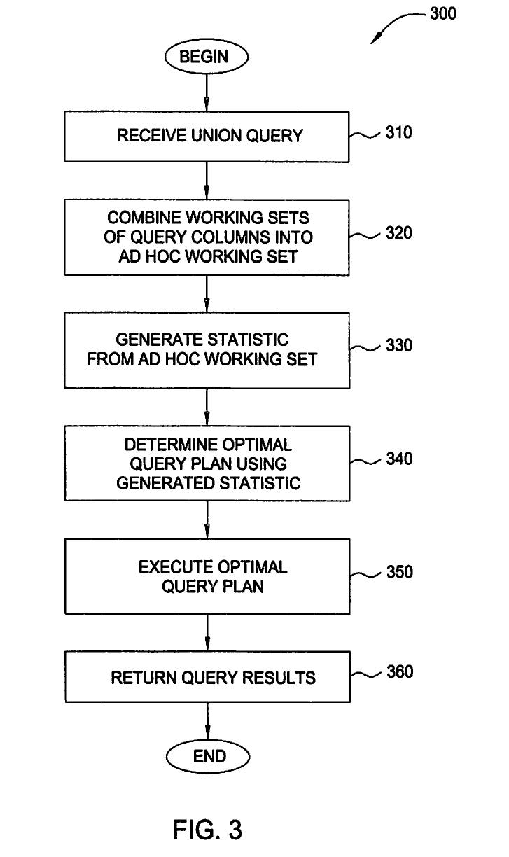

In one embodiment, the query optimizer 134 may be configured to optimize union queries based on statistics 146 that are generated to describe the union queries. More specifically, the working sets 144 describing the columns included in a union query may be combined to generate an ad hoc working set 136. Once generated, the ad hoc working set 136 may be used to generate a statistic 146 which describes properties of the specific union query. The ad hoc working sets 136 and any corresponding statistics 146 may be stored temporarily or persistently in the database 140. This process is further described below with reference to FIG. 3.

It is contemplated that the statistics 146 may be configured to optimize a union query joining data from more than two sources (e.g., columns, tables, etc.). In addition, statistics 146 may be configured to optimize a union of other queries, such as joins, aggregations (e.g., GROUP BY), etc. However, for the sake of clarity, the following examples of union queries are explained in terms of joining data from two sources. The relevant principles can then be extended for additional sources.

In one embodiment, the working sets 144 may also be maintained for use with non-union queries. This approach can be useful when the statistics 146 are not refreshed often enough. Conventionally, as data in the database 140 is added, deleted, or modified, the statistics 146 may become “stale,” meaning that they will no longer accurately describe the data in the columns of the database 140. In one embodiment, the working sets 144 may be maintained in the database 144 so that they reflect the current state of the data 142. That is, as database transactions are executed, and the data 142 is changed, the working sets 144 are incrementally updated to reflect those changes. Thus, when the statistics 146 are regenerated, the working sets 144 are already available, and accurately reflect the current state of the data 142.

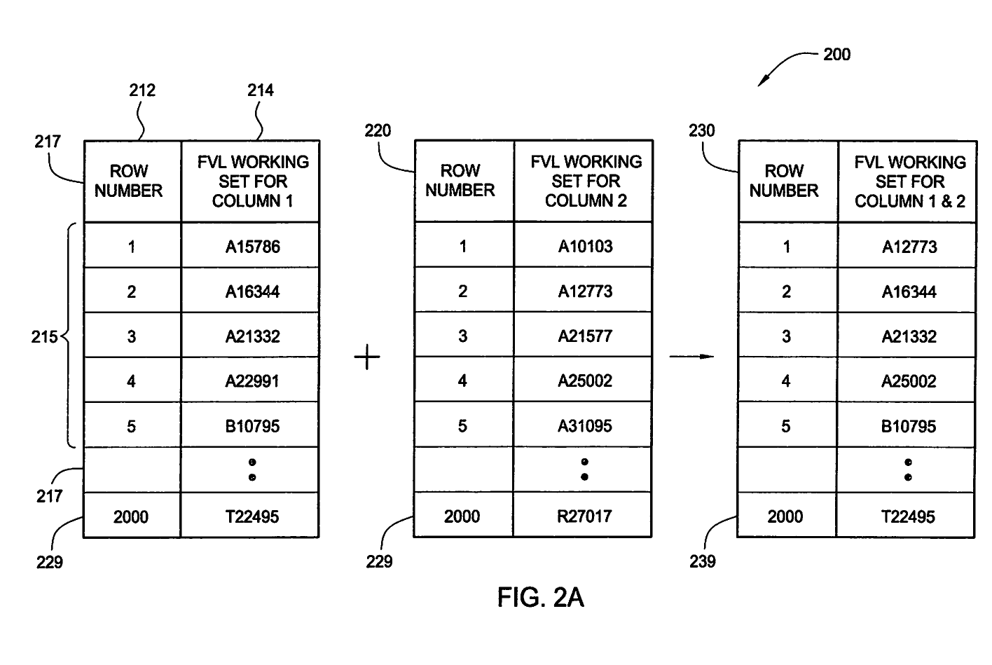

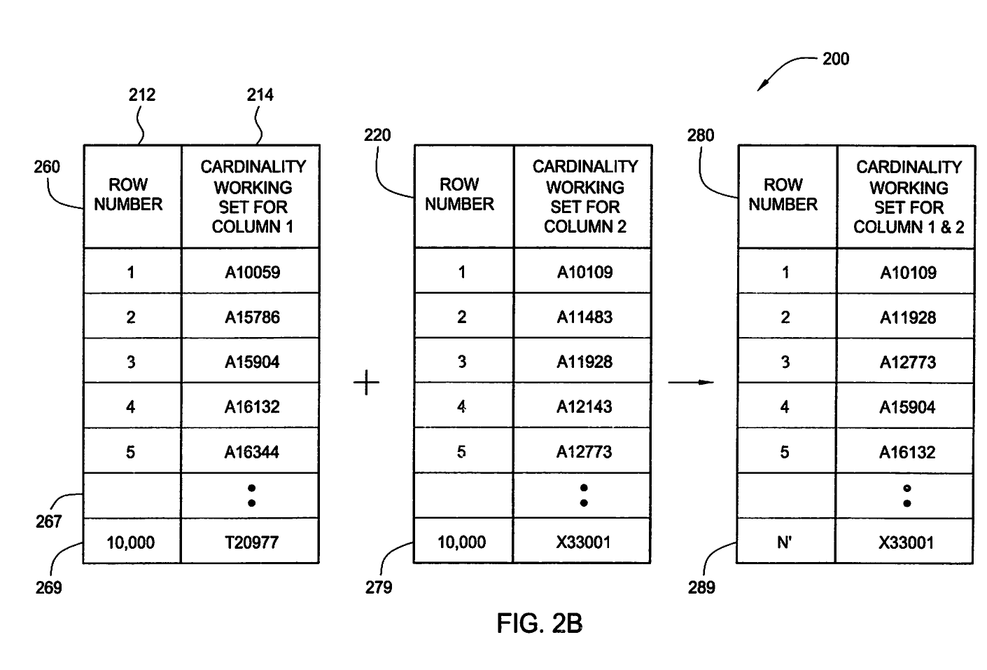

FIGS. 2A-2B illustrate a conceptual view 200 of exemplary working sets used for generating a database statistic for optimizing a union query, according to one embodiment of the invention. Illustratively, FIGS. 2A-2B correspond to a situation in which a union query is composed to join the data stored in two columns “COLUMN 1” and “COLUMN 2” (not shown). This exemplary union query may be written as:

### [Column 1] Union [Column 2]

The working sets 144 corresponding to “COLUMN 1” and “COLUMN 2” may be used to generate an ad-hoc working set 136, according to one embodiment. That is, the working sets 144, which include data sampled from the query columns (i.e., “COLUMN 1” and “COLUMN 2”), may be combined to produce an ad-hoc working set 136. Thus, the values included in the ad-hoc working set 136 may be assumed to serve as a “data sample” of the anticipated query results. The ad-hoc working set 136 may be used to generate a statistic 146 describing the results of the union query. The statistic 146 may then be used by the query optimizer 134 to select a query plan for executing the union query.

As illustrated in FIG. 2A, a working set 210 and a working set 220 may be combined to produce an ad hoc working set 230. The two working sets 210, 220 correspond, respectively, to the columns “COLUMN 1” and “COLUMN 2” (not shown) of the exemplary union query described above. A person of skill in the art will recognize that “COLUMN 1” and “COLUMN 2” may be located in the same table, may be located in separate tables of the same database, or may be located in separate databases. In this case, the working set 210 illustrates a FVL working set corresponding to “COLUMN 1.” That is, the working set 210 includes a sample of the values stored in “COLUMN 1,” and may be used to generate a FVL column statistic. Similarly, the working set 220 illustrates a FVL working set corresponding to “COLUMN 2.”

In one embodiment, the ad hoc working set 230 may be used to generate a FVL statistic 146 describing the anticipated results of the exemplary union query. Thus, the ad hoc working set 230 combines values of the working sets 210, 220. The FVL statistic 146 may be used by the query optimizer 134 to optimize the union query. That is, the values included in the FVL statistic 146 may be used by the query optimizer 134 to select a query plan for efficiently executing the union query.

As shown, the working set 210 includes a first column 212, indicating a row number for each row, and a second column 214, storing the values sampled from “COLUMN 1.” The working set 210 also includes rows of data. For the sake of brevity, only a set of first five rows 215 and a last row 219 of the working set 210 are shown. The remaining rows are represented by the row 217. The rows of the working set 220 and of the ad hoc working set 230 are illustrated in a similar manner.

As indicated by the first column 212 of the last row 219, the working set 210 includes 2000 records. Likewise, the last row 229 indicates that the working set 220 includes 2000 records. Thus, the working sets 210, 220 each represent a sample size of 2000 values. In this example, this sample size is sufficient to provide a FVL statistic having a required level of statistical accuracy. Of course, this example is provided for illustrative purposes, and is not intended to limit the scope of the invention.

As illustrated, the ad hoc working set 230 includes N rows. In one embodiment, the ad hoc working set may include all the values of the working sets it is derived from. Thus, in the example illustrated in FIG. 2A, the ad hoc working set 230 may include all rows of the working sets 210, 220, so N is equal to 4000. In another embodiment, the ad hoc working set may include a sub-set of the values of the working sets it is derived from. The sub-set of values may be determined by, for example, taking a random sample of values from the working sets. Thus, in the example illustrated in FIG. 2A, N is less than 4000. Of course, one of skill in the art will recognize that other methods of combining the working sets to generate the ad hoc working set may be used to suit particular situations, and are thus contemplated to be in the scope of the invention.

FIG. 2B illustrates a working set 260 for “COLUMN 1” and a working set 270 for “COLUMN 2.” The working sets 260, 270 include data sampled to determine cardinality statistics for the respective columns. As illustrated, the working sets 260, 270 may be combined to produce an ad hoc working set 280. The ad hoc working set 280 may be used to generate a cardinality statistic for the anticipated union query.

In one embodiment, the ad hoc working set 280 may be used to generate a cardinality statistic 146 describing the anticipated results of the exemplary union query. Thus, the ad hoc working set 280 combines values of the working sets 260, 270. The cardinality statistic 146 may be used by the query optimizer 134 to optimize the union query.

As indicated by the first column 262 of the last row 269, the working set 260 includes 10,000 records. Likewise, the last row 279 indicates that the working set 270 includes 10,000 records. Thus, the working sets 260, 270 each represent a sample size of 10,000 values. In this example, this sample size is sufficient to provide a cardinality statistic having a required level of statistical accuracy. Of course, this example is provided for illustrative purposes, and is not intended to limit the scope of the invention.

As illustrated, the ad hoc working set 280 includes N′ rows. In one embodiment, the ad hoc working set may include all the values of the working sets it is derived from. Thus, in the example illustrated in FIG. 2B, the ad hoc working set 280 may include all rows of the working sets 260, 270, so N′ is equal to 20,000. In another embodiment, the ad hoc working set may include a sub-set of the values of the working sets it is derived from. The sub-set of values may be determined by, for example, taking a random sample of values from the working sets. Thus, in this example, N′ may be less than 20,000. Of course, one of skill in the art will recognize that other methods of combining the working sets to generate the ad hoc working set may be used to suit particular situations, and are thus contemplated to be in the scope of the invention.

FIG. 3 illustrates a flow diagram 300 illustrating a method for generating database statistics for optimizing union queries, according to one embodiment of the invention. Persons skilled in the art will understand that, even though the method is described in conjunction with the systems of FIG. 1 and FIGS. 2A-2B, any system configured to perform the steps of method 300, in any order, is within the scope of the present invention.

The method 300 begins at step 310, when a union query is received. For example, a union query may be created by a user interacting with a query tool 108, and may be received by a DBMS 130 on a server system 120. At step 320, the working sets corresponding to the columns included in the union query are combined into an ad hoc working set. For example, the working sets 210 and 220 may be combined to form the ad hoc working set 230, as illustrated in FIG. 2A.

At step 330, the ad hoc working set is used to generate a statistic describing characteristics of the anticipated results of the union query. For example, the ad hoc working set 230 illustrated in FIG. 2A may be used to generate a FVL statistic describing the anticipated results of a union query of “COLUMN 1” and “COLUMN 2.” At step 340, the generated statistic is used to determine an optimal query plan. For example, a FVL statistic may be used by the query optimizer 134 to determine an optimal query plan.

At step 350, the optimal query plan is followed in order to execute the union query. For example, the optimal query plan may be carried out by the query engine 132. At step 360, the query results are returned. For example, the query results produced by query engine 132 according to the optimal query plan may be presented to a user in the query tool 108.

While the foregoing is directed to embodiments of the present invention, other and further embodiments of the invention may be devised without departing from the basic scope thereof, and the scope thereof is determined by the claims that follow.

What is claimed is:

1. A computer-implemented method for generating a database statistic for optimizing union queries, comprising:
receiving a union query for joining data from at least two data columns;
identifying at least two working sets, each comprising data values sampled from a different column of the at least two columns, wherein the at least two working sets are maintained persistently in a database;
generating an ad hoc working set comprising data values of the at least two working sets;
generating a database statistic based on the ad hoc working set, wherein the database statistic represents anticipated characteristics of query results to be returned for the union query; and
outputting the database statistic.

2. The computer-implemented method of claim 1, further comprising:
selecting, based on the database statistic, a query plan for executing the union query;
executing the selected query plan; and
returning a set of query results.

3. The computer-implemented method of claim 1, wherein each of the at least two working sets comprises a pre-determined number of data values based on a desired level of statistical accuracy.

4. The computer-implemented method of claim 1, wherein the database statistic is a list of the most frequent values included in the query results to be returned for the union query.

5. The computer-implemented method of claim 1, wherein the database statistic is a cardinality number for the query results to be returned for the union query.

6. The computer-implemented method of claim 1, wherein generating the ad hoc working set comprises a union of the data values of the at least two working sets.

7. The computer-implemented method of claim 1, wherein generating the ad hoc working set comprises a random combination of the data values of the at least two working sets, wherein the ad hoc working set comprises the same number of data values as contained in either of the at least two working sets.

8. A computer readable storage medium containing a program which, when executed, performs an operation, comprising:
receiving a union query for joining data from at least two data columns;
identifying at least two working sets, each comprising data values sampled from a different column of the at least two columns, wherein the at least two working sets are maintained persistently in a database;
generating an ad hoc working set comprising data values of the at least two working sets;
generating a database statistic based on the ad hoc working set, wherein the database statistic represents anticipated characteristics of query results to be returned for the union query; and
outputting the database statistic.

9. The computer readable storage medium of claim 8, further comprising:
selecting, based on the database statistic, a query plan for executing the union query;
executing the selected query plan; and
returning a set of query results.

10. The computer readable storage medium of claim 8, wherein each of the at least two working sets comprises a pre-determined number of data values based on the desired level of statistical accuracy.

11. The computer readable storage medium of claim 8, wherein the database statistic is a list of the most frequent values included in the query results to be returned for the union query.

12. The computer readable storage medium of claim 8, wherein the database statistic is a cardinality number for the query results to be returned for the union query.

13. The computer readable storage medium of claim 8, wherein generating the ad hoc working set comprises a union of the data values of the at least two working sets.

14. The computer readable storage medium of claim 8, wherein generating the ad hoc working set comprises a random combination of the data values of the at least two working sets, wherein the ad hoc working set comprises the same number of data values as contained in either of the at least two working sets.

15. A system, comprising:
a database;
a group of working sets maintained persistently in the database; and
a processor configured to:
receive a union query for joining data from at least two data columns;
identify at least two working sets from the group of working sets, each of the at least two working sets comprising data values sampled from a different column of the at least two columns;
generate an ad hoc working set comprising data values of the at least two working sets;
generate a database statistic based on the ad hoc working set, wherein the database statistic represents anticipated characteristics of query results to be returned for the union query; and
output the database statistic.

16. The system of claim 15, wherein the processor is further configured to:
select, based on the database statistic, a query plan for executing the union query;
execute the selected query plan; and
return a set of query results.

17. The system of claim 15, wherein each of the at least two working sets comprises a pre-determined number of data values based on the desired level of statistical accuracy.

18. The system of claim 15, wherein the database statistic is a list of the most frequent values included in the query results to be returned for the union query.

19. The system of claim 15, wherein the database statistic is a cardinality number for the query results to be returned for the union query.

20. The system of claim 15, wherein generating the ad hoc working set comprises a union of the data values of the at least two working sets.

21. The system of claim 15, wherein generating the ad hoc working set comprises a random combination of the data values of the at least two working sets, wherein the ad hoc working set comprises the same number of data values as contained in either of the at least two working sets.
